(19) United States
(12) Patent Application Publication
(10) Pub. No.: US 2021/0260902 A1
(43) Pub. Date: Aug. 26, 2021

(54) POSITIONING AID FOR A STAMPING TOOL

(71) Applicant: Tasnim Ahmed, Jamesville, NY (US)

(72) Inventor: Tasnim Ahmed, Jamesville, NY (US)

(21) Appl. No.: 17/316,425

(22) Filed: May 10, 2021

Related U.S. Application Data
(60) Provisional application No. 63/150,252, filed on Feb. 17, 2021.

(51) Int. Cl. B41K 3/62; B41K 3/02

(52) U.S. Cl. CPC B41K 3/62; B41K 3/02

(57) ABSTRACT

An assembly for precise positioning of a stamping tool, such as a photopolymer stamp. The assembly having a flat base of preferably a square shape. A platform of a predetermined height runs along the periphery of the flat base. A grid film removably adhered to the top surface of the flat base. Four alignment tabs can be provided on the four corners of the platform. A flip plate dimensioned to fit over the platform, such as corners of the flip plate juxtapose to the alignment tabs. A portion of the flip plate extends sidewards from the periphery of the platform, such as the flip plate can be lifted. The clear flip plate having radial lines that extend from the center to the periphery of the flip plate.

### CROSS-REFERENCE TO RELATED APPLICATIONS

This application claims priority to the U.S. provisional patent application Ser. No. 63/150,252, filed on Feb. 17, 2021, which is incorporated herein by reference in its entirety.

### FIELD OF INVENTION

The present invention relates to an assembly for positioning a stamping tool, and more particularly, the present invention relates to an assembly for precisely positioning a photopolymer stamp on an artistic media.

### BACKGROUND

Stamping is a common method for transferring a pattern to artistic media, such as greeting cards, cardstock, and paper. The pattern can be engraved on a rubbery stamping tool which can then be used to print the pattern on multiple artistic media. Ink can be first transferred to the stamping tool which can then be applied to the destined object.

Acrylic and photopolymer stamps are generally available in a range of designs for art and craft. For example, premade stamps are available for printing an artistic design on a greeting card. Photopolymer stamps are advantageous over acrylic stamps being able to produce more sharp and crispy patterns.

However, precisely aligning a stamp on an artistic media can be problematic. Additionally, it is common that the first attempt of stamping may not result in a clean impression, and repeated stamping may be needed. Realigning the stamping tool in the exact position as the previous position can be difficult.

Thus, a desire is there for an assembly that may allow precisely positioning a stamping tool on artistic media.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an assembly for precisely positioning a stamping tool.

It is another object of the present invention that the assembly is easy to use.

It is still another object of the present invention that the assembly is economical to manufacture.

In one aspect, disclosed is an assembly for precise positioning of a stamping tool, such as a photopolymer stamp. The assembly having a flat base of preferably a square shape. A platform of a predetermined height runs along the periphery of the flat base. A grid film removably adhered to the top surface of the flat base. Four alignment tabs can be provided on the four corners of the platform. A flip plate dimensioned to fit over the platform, such as corners of the flip plate juxtapose to the alignment tabs. A portion of the flip plate extends sidewards from the periphery of the platform, such as the flip plate can be lifted. The clear flip plate having radial lines that extend from the center to the periphery of the flip plate.

In one aspect, the grid film and the radial lines allow aligning the photopolymer stamp on the artistic media.

In one aspect, the height of the platform relative to the flat base is such as to accommodate the grid film, artistic media, and the photopolymer stamp.

In one aspect, the thickness of the four alignment tabs can be more than the thickness of the flip plate.

In one aspect, the flip plate over the platform can be retained over the platform between the four alignment tabs, wherein the alignment tabs prevent even slight lateral movements of the flip plate over the platform.

In one aspect, the flip plate can be transparent or translucent.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows the frame of the disclosed assembly having a flat base, a platform around the periphery of the flat base, and four alignment tabs at four corners of the platform, according to an exemplary embodiment of the present invention.

FIG. 2 shows the grid film of the assembly, according to an exemplary embodiment of the present invention.

FIG. 3 shows the flip plate of the assembly, according to an exemplary embodiment of the present invention.

FIG. 4 shows the disclosed assembly, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

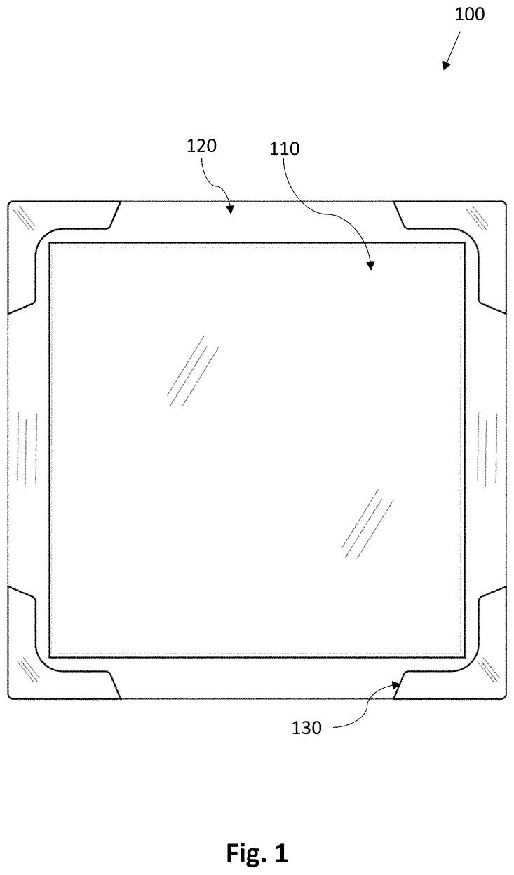

Referring to FIG. 1 which shows frame 100 of the disclosed assembly. The frame 100 can have a flat base 110 of preferably a square shape. The dimensions of the square base 110 can be such as to receive an artistic media i.e., the area of the flat base can be more than the dimensions of the artistic media. The artistic media can be card stock, invitation cards, contact cards, and like. Around the flat base 110 can be seen a platform 120 that runs along the periphery of the flat base 110. The platform 120 can also have a square periphery and a flat top surface. The height of the platform 120 above the flat base 110 can be such as to accommodate a grid film, artistic media, and the photopolymer stamp on the flat base. The height of the platform relative to the flat base can be proportional to the combined height of the grid film, the artistic media, and the photopolymer stamp. Photopolymer stamps of standard thickness are generally available. The height of the platform relative to the base can be varied based on the standard sizes of the photopolymer stamps.

At four corners of the platform 120 can be seen four alignment tabs 130. The alignment tabs 130 can have a wall of predefined height and a top surface. The inner side of the alignment tabs can be round with diagonal cuts at the ends. The width of the alignment tabs can be less than the width of the platform.

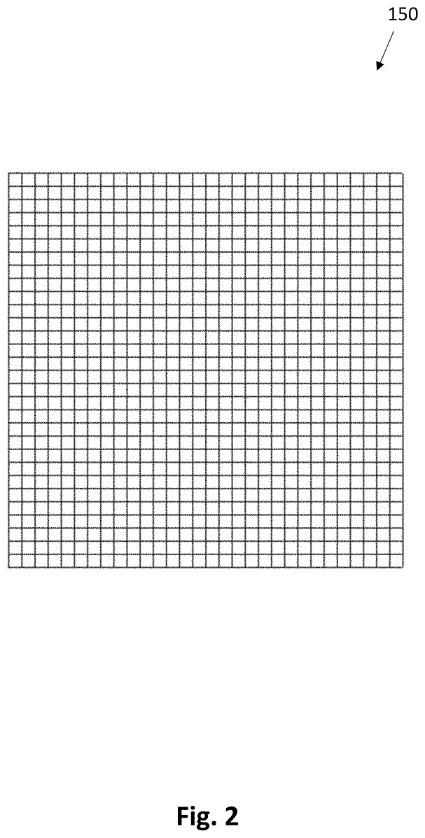

Referring to FIG. 2 which shows the grid film 150. The grid film has regularly spaced grid lines that may help to align the artistic media on the grid film. The grid film 150 can be dimensioned to be placed onto the flat base 110. The grid film 150 can be made of rubbery material, such as silicone that may allow removably adhering the grid film 150 to the flat base 110. The adhesive nature of the grid film may ensure that the grid film does not slip on the flat base. The artistic media on which pattern can be printed is placed on the grid film. The artistic media can be aligned relative to the grids of the grid film, moreover, the grid film may also have a scale to aid in the alignment of the artistic media.

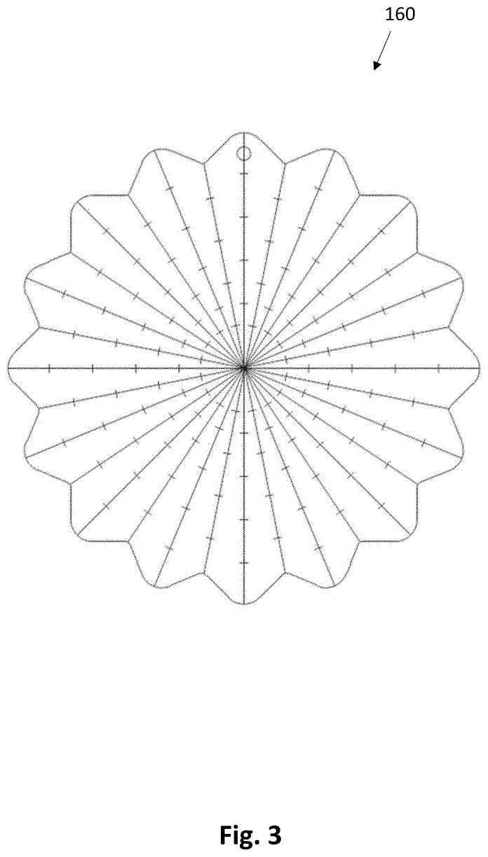

FIG. 3 shows the flip plate 160 of the assembly that can fit over the platform. Four corners of the flip plate can be juxtaposed with the four alignment tabs on the corners of the platform, such as the flip plate can fit over the platform. The round shape of the corners of the flip plate 160 can be dimensioned to align to the round inner wall of the alignment tabs 130. The flip plate can snugly and smoothly slide through the alignment tabs and be placed on the platform, such as to prevent any lateral movement of the flip plate. Moreover, the sides of the flip plate can extend sidewards of the platform, which may allow the flip plate to be lifted by grabbing through hands. The flip plate may be transparent to translucent and have radial lines that extend from the center to the periphery of the flip plate. In one case, the radial lines can be etched on the clear flip plate. The radial lines may aid in the precise alignment of the photopolymer stamp relative to the artistic media.

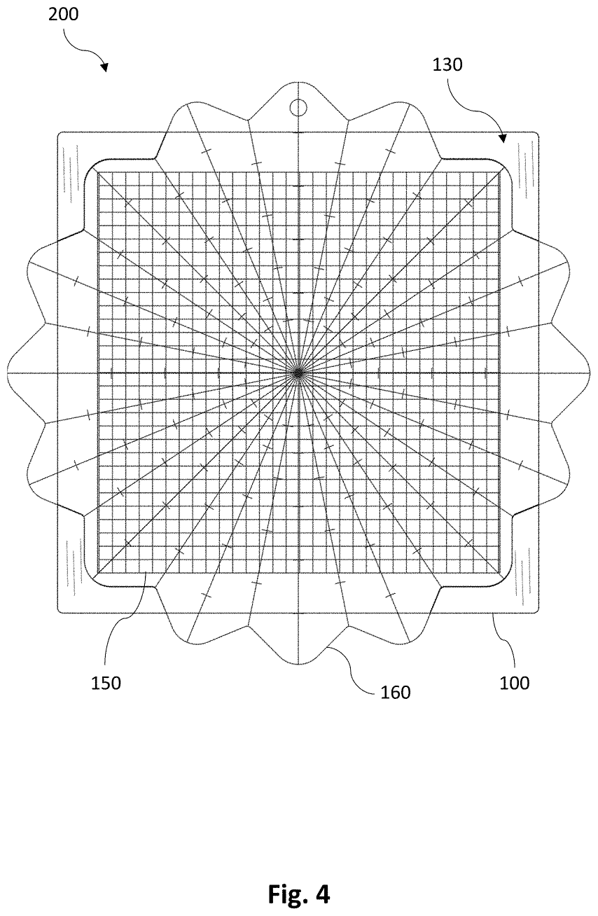

FIG. 4 shows the assembly 200 having the flat base on which the grid film 150 is placed. Moreover, the flip plate 160 can also be seen placed on the platform. For stamping, the grid film can adhere to the flat base. Thereafter, the card stock or similar artistic media can be placed over the grid film. The card stock can be positioned relative to the grid film, for example, edges of the card stock can be aligned to the grid. Thereafter, the stamp can be placed on the desired position on the artistic media. Once, the stamp is in place, the clear flip plate 160 can be fit onto the platform, wherein corners of the flip plate 160 can be aligned to the alignment tabs 130 of the platform. The polymeric stamp adheres to the inner surface of the flip plate 160. Suitable pressure may be applied to the flip plate for adhering to the stamp. Once, the stamp adheres to the flip plate, the flip plate can be removed and inverted. The ink can then be applied to the stamp. For example, the round ink pad can be used to transfer ink to the stamp. Thereafter, the clear flip plate can be again inverted and placed onto the platform. Moreover, slight pressure may also be applied to the flip plate to uniformly transfer the ink pattern to the artistic media. In case, the ink is not uniform in the pattern, the process can be repeated i.e., the flip tab can be removed, and ink applied again to the stamp. The flip plate can then be put on the platform to transfer the ink to the artistic media.

The grid film can be made of any soft material, such as rubber that adheres to a surface and resist slip. Such material are known to provide grip. Also, known as slip resistant rubber or silicone. The grid film can adhere to the top surface of the base and the artistic media, such as the artistic media does not slip.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An assembly for positioning a stamping tool, the assembly comprising:
a frame comprising:
a base having a flat top surface, the base dimensioned to receive an artistic media;
a flat platform along a periphery of the base, the flat platform is of a predefined height relative to the flat top surface of the base;
a plurality of alignment tabs coupled at corners of the flat platform, the plurality of alignment tabs having an inner side; and
a flip plate dimensioned to fit over the flat platform between the plurality of alignment tabs, wherein the plurality of alignment tabs restricts lateral movement of the flip plate.

2. The assembly according to claim 1, wherein the assembly further comprises a grid film dimensioned to be received on to the flat base, the grid film made of a rubbery material configured to permit the grid film to be removably adhere to the flat top surface of the base, the grid film having a grid.

3. The assembly according to claim 1, wherein the flip plate is having a plurality of radial lines that extends from a center of the flip plate up to its periphery.

4. The assembly according to claim 3, wherein the flip plate is transparent or translucent.

5. The assembly according to claim 1, wherein the base is square having four corners, the flat platform is having a square periphery and four corners, and four alignment tabs are at the four corners of the flat platform.

6. The assembly according to claim 1, wherein corners of the flip plate juxtapose to the inner side of the plurality of alignment tabs.

7. The assembly according to claim 6, wherein the inner side of the plurality of alignment tabs is concave, shape of the corners of the flip plate is round that corresponds to the concave inner side of the plurality of alignment tabs.

8. The assembly according to claim 6, wherein the flip plate is substantially round.

9. A method of stamping an artistic media using a photopolymer stamp, the method comprises the steps of:
providing an assembly for positioning a stamping tool, the assembly comprising:
a frame comprising:
a base having a flat top surface and dimensioned to receive an artistic media,
a flat platform along periphery of the base, the flat platform is of a predefined height relative to the flat top surface of the base,
a plurality of alignment tabs coupled at corners of the flat platform,
the plurality of alignment tabs having an inner side,
a flip plate dimensioned to fit over the flat platform between the plurality of alignment tabs, wherein the plurality of alignment tabs restricts lateral movement of the flip plate, and
a grid film configured to removably couple to the flat top surface of the base, the grid film having a grid;
placing the artistic media on the grid film, the grid film on the flat top surface of the base;
upon placing the artistic media, positioning the photopolymer stamp on the artistic media;
upon positioning the photopolymer stamp, placing the flip plate on the flat platform and between the plurality of alignment tabs, such as the photopolymer stamp adheres to a bottom surface of the flip plate;
removing the flip plate from the flat platform and thereafter inverting the flip plate;
applying ink to an exposed surface of the photopolymer stamp adhered to the flip plate;
upon applying the ink, inverting, and repositioning the flip plate over the flat platform, such as the photopolymer stamp contacts the artistic media.

10. The method according to claim 9, wherein the flip plate is having a plurality of radial lines that extends from a center of the flip plate up to its periphery.

11. The method according to claim 10, wherein the flip plate is transparent or translucent.

12. The method according to claim 9, wherein the base is square having four corners, the flat platform is having four corners, and four alignment tabs are at the four corners of the flat platform.

13. The method according to claim 9, wherein corners of the flip plate juxtapose to the inner side of the plurality of alignment tabs.

14. The method according to claim 13, wherein the inner side of the plurality of alignment tabs is concave, shape of the corners of the flip plate is round that corresponds to the concave inner side of the plurality of alignment tabs.

15. The method according to claim 14, wherein the flip plate is substantially round.

16. The method according to claim 9, wherein the grid film is made of soft material configured to adhere to the flat top surface of the base and the artistic media.
